(19) United States
(12) Patent Application Publication
(10) Pub. No.: US 2009/0218053 A1
(43) Pub. Date: Sep. 3, 2009

(54) Removable device for ballasting a shower curtain without perforating same

(76) Inventor: Antoine Gallon, Marseille (FR)

Correspondence Address: JEROME D. JACKSON (JACKSON PATENT LAW OFFICE), 211 N. UNION STREET, SUITE 100, ALEXANDRIA, VA, 22314, US

(21) Appl. No.: 11/914,462

(22) PCT Filed: May 12, 2006
(86) PCT No.: PCT/FR06/01077

§ 371 Date: Jun. 24, 2008

(30) Foreign Application Priority Data
May 16, 2005 (FR) 0504890

(51) Int. Cl. A47H 23/01; B23P 11/00

(52) U.S. Cl. 160/349.1; 29/428

(57) ABSTRACT

The invention relates to a removable device which can be used to ballast a shower curtain without perforating same, such that the curtain remains vertically in place and does not stick to a person taking a shower. The inventive device comprises only two parts, including a first ballast part (1) which is equipped with a hole (2). According to the invention, part of the curtain (4) is passed through the hole (2), followed by the second part of the device, which takes the form of an elongated element (3). The device is then fixed to the curtain (4) by positioning the second part (3) across the hole (2) once it has been passed fully through same. The length of the second part is greater than the diameter of the hole (2) and, as a result, the second part and the curtain (4) cannot pass back through the hole. Said system is duplicated across the lower end of the curtain (4) in order to provide an adequate, uniform ballast.

The present invention relates to a removable device making it possible to ballast a shower curtain without perforating it, so that the curtain remains vertically in place and does not stick itself to the person taking his shower.

The most general current solution, enabling resolution of this annoyance, includes replacing the traditional shower curtain by a shower cubicle. It is a solution certainly effective but expensive.

The new technical solution applied here is economical and does not require replacement of the shower curtain.

The device is universal. It adapts to any curtain.

It is constituted by only 2 parts. The first part (1), designed to ballast, has an orifice (2). By passing from the same side of this orifice (2) a part of the curtain (4), followed by the second part having elongated shape (3), one fixes the device to the curtain (4) by putting across the orifice (2) this second part (3) when it has been completely inserted. In fact, its length, greater than the diameter of the orifice (2), prevents it from re-emerging as well as the curtain (4).

Then one spreads this device on the entire width of the lower part of the curtain (4) to obtain a sufficient and homogeneous ballast.

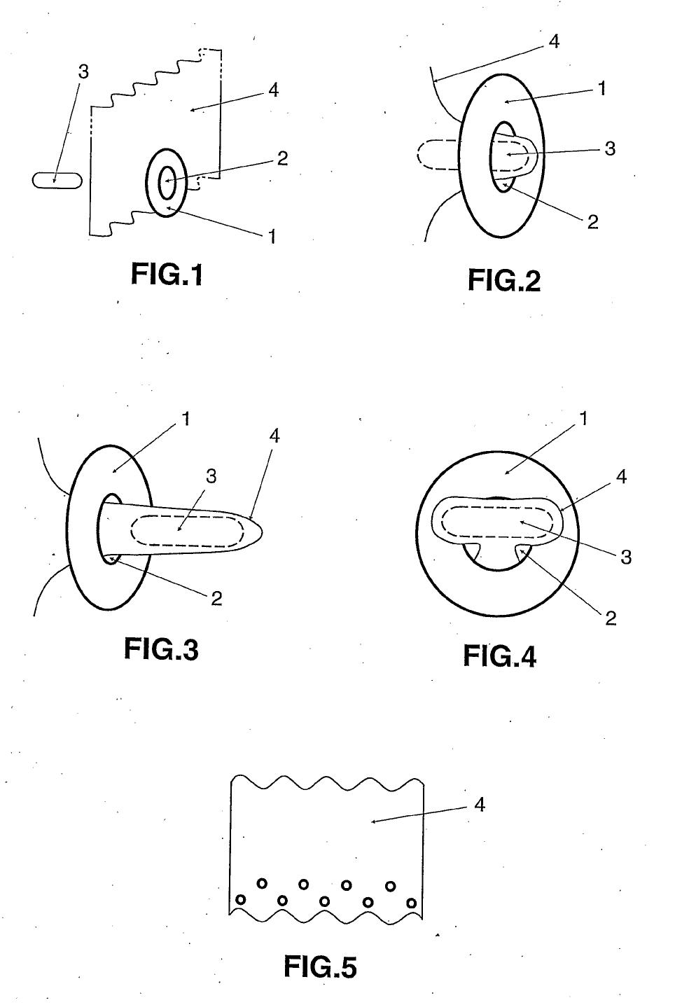

The figures FIG. 1; FIG. 2; FIG. 3; FIG. 4; FIG. 5 of page 1/1 illustrate the various stages of the assembly of the device.

The device is very simple. It is constituted by only of 2 parts.

The 1st part is that which will constitute the ballast.

This 1st part will be called “the hooked part” (1) in this document.

It is characterized by an orifice (2), and can have the shape of a washer (such as tooling washer that one uses with a nut and a screw).

Many shapes provided with an orifice could be appropriate and it is not possible of to list them all. But the benefit of choosing a shape like that of the washer allows avoidance of angles and thus any risk of tear of the curtain (4).

A plane shape having small thickness more easily adapts and better holds the curtain (4) by pinching it on a greater surface cf. FIG. 4.

A central orifice (2), for its part, makes it possible to have a homogeneous distribution of the mass. The ballast thus does not rotate under the effect of its weight when it is installed on the curtain (4).

This part has the ballast function. It would be advisable to manufacture it in a dense material such as a metal or an alloy (stainless preferably).
The 2nd part is that which will make it possible to attach the hooked part (1) at the curtain (4).

This 2nd part will be called “the hook” (3) in this document.

It has an elongated shape and could have the shape of a stick (such as an “ice cream bar” stick).

Its dimensions conform to the following restrictions:
Having a length strictly greater than the diameter of the orifice (2) of the hooked part (1) in at least a spatial configuration.
Having a width strictly less than the diameter of the orifice (2) of the hooked part (1) in at least a spatial configuration.

Many elongated shapes could be appropriate and it is not possible to list them all. But here are some nonrestrictive examples of shapes being the most appropriate:
a stick in the shape of an “ice cream bar” stick.
a stick in the shape of a bow tie.
a cylinder rounded at the ends.
a thin metal or alloy rod folded up in the shape of an 8.
a thin metal or alloy rod folded up in the shape of an oval.

The coupling principle somewhat resembles the manner that one buttons a shirt! The technique to attach this device to the curtain (4) is very simple and takes a few seconds.

In a first step cf. FIG. 1, the curtain (4) must absolutely be placed between the hooked part (1) and the hooking part (3), preferably with the hooked part (1) located on the external side of the curtain (4) and the hooking part (3) located on the interior side of the curtain (4).

In a second step cf. FIG. 2, it suffices to pass the hooking part (3) into the orifice (2) of the hooked part (1) by introducing it surrounded by a part of the curtain (4).

Then, once the hooking part (3) is completely is inserted and reemerged from the other side of the orifice (2) cf. FIG. 3, one flattens it onto the hooked part (1) so that the longitudinal axis of the hooking part (3) is perpendicular to the axis of the orifice (2) cf. FIG. 4.

It results from this handling that the curtain (4) is held between the 2 parts, that that the hooked part (1) remains well in place, as well as the hooking part (3) which cannot reemerge because its length is greater than the diameter of the orifice (2). Let us also remember than its width is less than the diameter of the orifice (2), without which it would be impossible to insert it.

This ballast device ballasts in a targeted manner (specific) the zone of the curtain on which it is installed. This is why it is appropriate to spread the installation of this device (with as many identical devices as proves itself to be necessary) over the entire width of the curtain, to homogenize the ballast and to weigh down the curtain to the desired level. A provision in staggered rows in the bottom part of the curtain proves to be particularly effective cf. FIG. 5.

For marketing purposes and for aesthetic reasons, it could be possible to attach on the device (already installed) a decorative masking on the hooked part, this degrading none of its functionalities. This masking could be clipped or attached by elastic deformation or in any other manner (nonrestrictive examples of attachments).

The device according to the invention is particularly designed for ballasting shower and bathtub curtains. But it is possible to widen its field of ballast application to:
interior curtains.
theatre or performance room curtains.
any kind of sails.
fabrics (clothing, use in the fashion).

1-9. (canceled)

10. Removable device making it possible to ballast a shower curtain or a fabric without perforating it, characterized in that is composed of two parts,
an anchored part designed to ballast,
provided with an orifice contained in a washer or in any other shape without salient angles in order to avoid tears in the curtain or fabric,
and an anchoring part, designed to attach the anchored part to the curtain or fabric,
having a shape such that it can be completely inserted through the orifice,
the anchoring part having its width strictly less than the diameter of the orifice of the anchored part in at least a spatial configuration,
and the anchoring part having its length strictly greater than the diameter of the orifice of the anchored part in at least a spatial configuration.

11. Removable device according to claim 10 characterized in that the anchored part, fabricated of a dense material such as a metal or a stainless alloy, is a plane shape and of small thickness.

12. Removable device according to claim 10 characterized in that the anchoring part has one of following shapes:
a stick in the shape of dietary ice cream support stick
a stick in the shape of a bow tie
a cylinder rounded at the ends
a thin metal or alloy stem folded up in the shape of an 8
a thin metal or alloy stem folded up in the shape of an oval.

13. Removable device according to claim 10 characterized in that a decorative masking is attached on the device after its installation on the curtain or fabric, the attachment being realized by clipping or by attachment by elastic deformation.

14. Application of the device according to claim 10 to ballast without perforating:
shower curtains
interior curtains
theatre or performance room curtains
fabrics.

15. Process of ballasting a shower curtain using a device according to claim 10 characterized in that it includes passing, from a common side of the hooked part, through the orifice, a part of the curtain or fabric followed by the hooking part, the latter being placed across the orifice after having been completely passed in the orifice, thus holding the curtain or fabric, and the hooking part being prevented from reemerging from the orifice due to its appropriate dimensions.

16. Process of ballasting according to claim 15 characterized in that it includes installing several of these removable devices over the entire the width of the curtain or fabric, so as to homogenize the ballast and to weight down the curtain or the fabric to the desired level.

17. Process according to claim 16 characterized in that the removable devices are distributed in staggered rows on the bottom part of the curtain or fabric.

18. Process of disassembly of a removable device that ballasts without perforating a shower curtain or a fabric characterized in that the disassembly is effectuated according to the strict inverse sequence of the specific ballasting process according to claim 15.
